(19) United States
(12) Patent Application Publication
(10) Pub. No.: US 2023/0179056 A1
(43) Pub. Date: Jun. 8, 2023

(54) STATOR CORE, STATOR, AND POWER GENERATION SYSTEM HAVING THE SAME

(71) Applicant: SISCRENER GLOBAL COMPANY LIMITED, Samutsakom (TH)

(72) Inventors: Guillermo Enzo QUIÑONES BASCUÑÁN, Santiago (CL); Christian Jacob NEDER, Santiago (CL)

(21) Appl. No.: 17/921,211

(22) PCT Filed: Apr. 30, 2020
(86) PCT No.: PCT/IB2020/054053

§ 371 Date: Oct. 25, 2022

(51) Int. Cl. H02K 3/47; H02K 15/06

(52) U.S. Cl. CPC H02K 3/47; H02K 15/061; H02K 2213/03

(57) ABSTRACT

To provide a stator core which is configured to substantially reduce the effects of electromagnetic brake and thus improve the efficiency of power generation, and to provide a power generation system capable of implementing such stator core to improve the efficiency of power generation, a stator core for power generation by magnetic or electromagnetic induction, comprising a nucleus; and a wire, wound around said nucleus, wherein the wire is wound towards a winding direction such as to form a plurality of wire intersections, is disclosed herein.

### FIELD OF INVENTION

The present disclosure relates to power generation, particularly to a stator core for power generation systems.

### BACKGROUND OF THE INVENTION

A power generation system utilizing the conversion of mechanical energy normally comprises a system having a rotor and a stator. A stator is known to have one or a plurality of stator cores, each constructed by winding an electrically inductive wire around a magnetic core or nucleus. Operation of such power generator induces magnetic fields that cause a reaction force acting against the direction along which the rotor is intended to move, thereby retarding the power-generating rotation. This “electromagnetic brake” results in the loss of mechanical energy input into the system and thus reduces the power generation efficiency.

Many past publications proposed attempts to improve the output of power generators. For example, US 2010/019,608 A1 suggests a stator having a plurality of parallel wire slots in its inner side, so as to provide a larger induction area and consequently to avoid magnetic saturation. US 2006/290,224 A1 discloses a power generator made up of two or more permanent magnets spaced at a set distance with their opposite poles facing each other. Further, U.S. Pat. No. 9,584,056 B2 provides a polyphasic multi-coil generator to address the problem of narrow optimal range of rotational speed, outside of which the power generation efficiency would drop.

None of the foregoing has effectively addressed the problem of electromagnetic brake.

### SUMMARY OF THE INVENTION

A concept of the present disclosure relates to providing a stator core which is configured to substantially reduce the effects of electromagnetic brake and thus improve the efficiency of power generation. Another concept of the present disclosure relates to providing a power generation system capable of implementing such stator core to improve the power generation. Accordingly, the present disclosure provides embodiment examples to illustrate aspects and enablement of such concept. The preferred embodiment will be described in detail later on.

Unless specified otherwise, the term “electromagnetic brake” mentioned herein is intended by the applicant to mean a reaction force acting against the direction along which a power generator's rotor is intended to move, thereby diminishing the power-generating rotation.

Unless indicated otherwise, certain terminologies are used in the following description for general illustration purpose only and shall not be construed to limit the scope of the concept of the present disclosure in any way. Likewise, any specific configurations, figures and dimensions herein are for illustrating purpose and should not be construed to limit the scope of the concept of this technical disclosure.

In the first aspect, an embodiment is a stator core for power generation by magnetic or electromagnetic induction, comprising a nucleus; and a wire, wound around said nucleus, wherein the wire is wound towards a winding direction such as to form a plurality of wire intersections.

In the second aspect, an embodiment is a stator for power generation by magnetic or electromagnetic induction, comprising at least one stator core and a receptacle for holding the stator core, wherein the stator core comprises a nucleus and a wire, wound around said nucleus, and wherein the wire is wound towards a winding direction such as to form a plurality of wire intersections.

In the third aspect, an embodiment is a system for power generation by magnetic or electromagnetic induction, comprising (i) at least one rotor, configured to be capable of rotating around an axis and comprising at least one magnet, which may be a permanent magnet or an electromagnet; and (ii) at least one stator, configured to be stationary and comprising at least one stator core, wherein the stator core comprises a nucleus; and a wire, wound around said nucleus; wherein the wire is wound towards a winding direction such as to form a plurality of wire intersections; and said system being configured to receive mechanical energy for inducing the rotor to rotate around the axis. Optionally, the stator has at least one receptacle for holding the stator core.

An embodiment in accordance with the abovementioned first, second, and third aspects may be configured so that each wire intersection forms two pairs of opposite angles, each angle of the first pair denoted as p and each angle of the second pair denoted as q, wherein p faces generally away from the winding direction and q faces generally along the winding direction.

Preferably, the angle p is 90 degrees.

Further, an embodiment's nucleus is preferably non-magnetizable, and more preferably an air core.

An embodiment in accordance with the abovementioned second or third aspect may be preferably configured so that the embodiment's receptacle has a substantially symmetric shape. While the embodiment's receptacle may be formed of a wide range of materials, the receptacle is preferably formed of an electrical insulation material, and more preferably formed of molded fiberglass.

In an embodiment in accordance with the abovementioned second or third aspect, the stator is for generation of one or more electricity phase(s), wherein it is preferable that the stator comprises a plurality of stator cores. Even more preferably, the number of such plurality of stator core(s) is a multiple of the number of electricity phase(s) intended to be generated. Moreover, if such embodiment's receptacle is for holding a plurality of stator cores, such receptacle is preferably configured to hold the plurality of stator cores such that the positions of stator cores are evenly distributed. Further, the plurality of stator cores are electrically connected in pair, pairs, or an odd number.

In an embodiment in accordance with the abovementioned third aspect, the system is for generation of one or more electricity phase(s), wherein it is preferable that the rotor comprises a plurality of magnets. More preferably, the number of such plurality of magnets (N_{RM}) is determined by rounding up the product of an expression:

$${N}_{RM} = ( 1 + \frac{1}{{N}_{EP}} ) \times {N}_{SC} \qquad Formula ( 1 )$$

wherein N_{EP} is the number of intended electricity phase(s), and N_{SC} is the number of stator core(s). Examples of calculation will be provided in the later part of this Summary.

Preferably, the magnet(s) and the nucleus/nuclei have substantially the same cross-sectional dimensions.

It is also preferable that the system comprises a plurality of stators and/or a plurality of rotors. More preferably, the system comprises a plurality of stators and a plurality of rotors, such pluralities of stators and rotors being aligned coaxially, alternately, and free of a direct contact.

In an embodiment in accordance with the abovementioned third aspect, it is also preferable to configure the rotor(s) and stator(s) and their alignment such that each stator core is exposed to a rotor's magnet at any instance during the intended operation. Such is preferably enabled by configuring (i) a first imaginary circle having the perimeter upon which the center(s) of all stator core(s) lies; and (ii) a second imaginary circle having the perimeter upon which the center(s) of all rotor's magnet(s) lies, to have about the same sizes; and by aligning the rotor(s) and stator(s) so that such first and second imaginary circles are concentric.

An embodiment in accordance with the abovementioned third aspect may be configured so that the rotor comprises a plurality of the magnets. In such cases, the number of magnets in a rotor preferably depends on the number of stator core(s) in a stator and a coefficient determined by the number of electricity phase(s) intended to be generated. More preferably, the calculation is expressed as:

$$C = 1 + \frac{1}{{N}_{EP}} \qquad Formula ( 2 )$$

$${N}_{RM} = C \times {N}_{SC} \qquad Formula ( 3 )$$

wherein C=coefficient; N_{EP}=number of intended electricity phase(s); N_{RM}=preferred number of rotor's magnet(s) in a rotor; and N_{SC}=number of stator core(s) in a stator. Note that substituting the expression of C per Formula (2) into Formula (3) yields Formula (1) above.

Examples of calculation: for a two-phase power generation, C is 1+½=1.5; for a three-phase generation, C is 1+⅓=1.33; for a four-phase power generation, C is 1+¼=1.25; and so on.

For further example, where there are three stator cores held by a stator's receptacle for three-phase power generation, C is 1.33 and thus the preferred number of magnets in a rotor is N_{RM}=1.33×3=3.99, rounded up to four magnets per one rotor. Similarly, where six stator cores are held by a stator's receptacle for three-phase power generation, C is 1.33 and thus the preferred number of magnets in a rotor is N_{RM}=1.33×6=7.98, rounded up to eight magnets per one rotor, and so on.

In an embodiment in accordance with the abovementioned third aspect where the preferred number of magnets based on Formula (1) (or, equivalently, (2) jointly with (3)) is implemented, the preferred diameter of stator core depends on the diameter of magnet. More preferably, the calculation is expressed as:

D_{SC,I}=D_{RM} Formula (4)

D_{SC,O,max}=2×C×D_{RM} Formula (5)

wherein D_{SC,I}=preferred inner diameter of stator core, defined by the diameter of stator core's nucleus; D_{RM}=diameter of rotor's magnet; D_{SC,O,max}=preferred maximum outer diameter of stator core, defined by the diameter formed by the layer(s) of wire being wound around the stator core's nucleus; and C=coefficient per the above Formulas (2) and (3).

For example, where a magnet having a diameter of 30 mm is used for three-phase power generation (C=1.33), the inner diameter of stator core is preferably D_{SC,I}=D_{RM}=30 mm; then the outer diameter of stator core is preferably not larger than D_{SC, O, max}=2×1.33×30=79.8 mm.

For further example, where a magnet having a diameter of 30 mm is used for four-phase power generation (C=1.25), the inner diameter of stator core is preferably D_{SC, I}=D_{RM}=30 mm; then the outer diameter of stator core is preferably not larger than D_{SC, O, max}=2×1.25×30=75 mm.

In addition, the stator core's thickness is preferably smaller than D_{SC, I} or D_{RM} for generation of any phase type of electricity.

In an embodiment in accordance with the abovementioned third aspect, it is preferable as well to position the rotor(s) and stator(s) so that during the intended operation, all the stator core(s) in the same stator's receptacle for generation of the same phase of electricity is exposed to the same magnetic polarity at the same instance. In an embodiment that a plurality of stators are coaxially aligned, such is preferably enabled by placing the stator cores for generation of same electricity phase at a first position (or first set of positions) in a preceding stator and at a second position (or second set of positions) in a succeeding stator, wherein the second position/set of positions forms an angular displacement from the first position/set of positions. In an embodiment having more than two stators being coaxially aligned, it is preferred that such angular displacement is incremental from one stator to the next. In such cases, it is more preferable that the increment of angular displacement is expressed as:

$$θ = \frac{360 °}{{N}_{RM}} \qquad Formula ( 6 )$$

wherein θ=preferred increment of angular displacement (in degrees); and N_{RM}=preferred number of rotor's magnet(s) in a rotor per the above Formula (1) or (3).

For example, where the preferred number of rotor's magnets is eight and such number is implemented, the preferred increment of angular displacement from one stator to the next is

$$θ = \frac{360 °}{8} = 45 degrees .$$

This means the stator core(s) for generation of an electricity phase in any stator is placed 45 degrees apart from the stator core(s) for generation of same electricity phase in the adjacent stator(s).

In an embodiment in accordance with the abovementioned third aspect where there are a plurality of magnets per one rotor, the magnets may be preferably positioned such that, viewing at each face of the rotor, any one of the magnets has a polarity that is opposite to the polarity of the adjacent magnets.

Embodiments in accordance with the concept of the present disclosure may be adjusted within the same concept to accommodate either serial or parallel connection.

For a better understanding of the technical concept, preferred embodiments of the aspects will now be described in details, by way of non-limiting examples only, with reference to the accompanying drawings.

### BRIEF DESCRIPTION OF DRAWINGS

FIG. 1A shows a preferred embodiment of a stator core in accordance with aspects of the present technical concept (not to scale).

FIG. 1B shows a magnified view of a stator core winding in accordance with portion I of FIG. 1A, per a preferred embodiment (not to scale).

FIG. 2 shows a preferred embodiment of a stator in accordance with aspects of the present technical concept (not to scale).

FIG. 3A shows a preferred axial alignment of a plurality of stators in accordance with aspects of the present technical concept (not to scale).

FIG. 3B shows a preferred angular alignment of stator core in a plurality of stators when aligned in accordance with aspects of the present technical concept (not to scale).

FIG. 3C shows a preferred serial connection of stator cores for one electricity phase in a plurality of stators when aligned in accordance with aspects of the present technical concept (not to scale).

FIG. 3D shows a preferred serial connection of stator cores for three electricity phases in a plurality of stators when aligned in accordance with aspects of the present technical concept (not to scale).

FIG. 4 shows a preferred embodiment of a rotor in accordance with aspects of the present technical concept (not to scale).

FIG. 5A shows a preferred assembly of rotors and stators in accordance with aspects of the present technical concept (not to scale).

FIG. 5B shows a preferred axial alignment of a rotor, stator, and their features when assembled in accordance with aspects of the present technical concept (not to scale).

FIG. 5C shows a preferred angular alignment of a rotor, a plurality of stators, and their features when assembled in accordance with aspects of the present technical concept (not to scale).

FIG. 6 shows a preferred embodiment of a power generation system in accordance with aspects of the present technical concept (not to scale).

FIG. 7 shows a magnified view of a stator core winding per an alternative embodiment (not to scale).

FIG. 8A shows a parallel connection of stator cores for one electricity phase in a plurality of stators per an alternative embodiment (not to scale).

FIG. 8B shows a parallel connection of stator cores for three electricity phases in a plurality of stators per an alternative embodiment (not to scale).

### DETAILED DESCRIPTION OF EMBODIMENTS OF THE INVENTION

It should be noted that the following description is provided to describe preferred embodiments, by way of example only. Any specific configurations, figures and dimensions herein are for illustrating purpose and should not be construed to limit the scope of the concept of this technical disclosure.

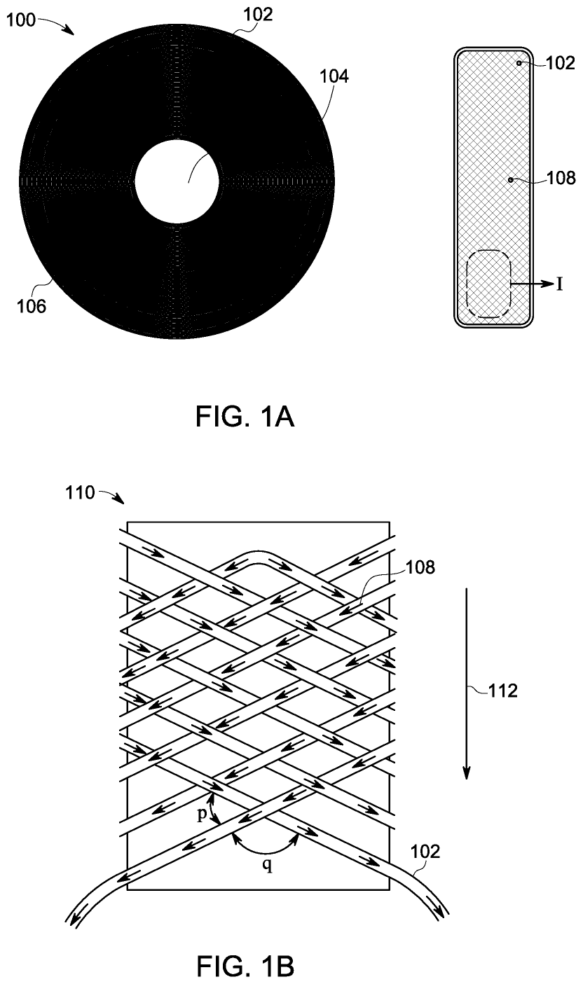

FIG. 1A shows an embodiment of a stator core 100 for power generation in accordance with aspects of the present technical concept. In this preferred embodiment, the stator core 100 is constructed of a solid copper stator-core wire 102 having a circular cross-section with a diameter of 0.32 mm. Said construction is carried out by winding the stator-core wire 102 around a nucleus. Such nucleus is preferably a non-magnetizable core, because a magnetizable core may cause additional electromagnetic brake during the intended rotation. In the case of a preferred embodiment, the nucleus is an air core 104, around which layers of the stator-core wire 102 is being wound, forming a generally cylindrical spool 106. Here, a diameter defined by the opening provided by the air core 104 is the stator core's 100 “inner diameter”, represented as D_{SC, I}; and a diameter defined by the outermost layer of stator-core wire 102 being wound around the air core 104 and forming the spool 106 is the stator core's 100 “outer diameter”, represented as D_{SC, O}. In a preferred embodiment, D_{SC, I}=30 mm; D_{SC, O}=70 mm, and the thickness of stator core 100 is 12 mm. Further, the stator-core wire 102 is wound such that to form a plurality of wire intersections 108 along the length of the same stator-core wire 102 forming the same spool 106.

FIG. 1B shows further details in regard to the forming of wire intersections 108 per a preferred embodiment. In particular, FIG. 1B depicts an isolated layer 110 formed of the winding of stator-core wire 102. In a preferred embodiment, a plurality of such layers 110 stack concentrically around the air core 104 (not shown in FIG. 1B), forming the spool 106 per the previously described FIG. 1A. Here, the stator-core wire 102 is wound towards a predetermined winding direction 112 such that the stator-core wire 102 is crossed and woven, and the wire intersections 108 are formed, within the same layer 110. Regardless, the wire intersections 108 in accordance with the concept of the present disclosure may be formed by different ways of winding, which shall be described later as an example of alternative embodiment.

Per FIG. 1B, each wire intersection 108 form two pairs of opposite angles, each angle of the first pair being denoted asp and each angle of the second pair being denoted as q, wherein p faces generally away from the winding direction 112 and q faces generally along the winding direction 112. The wire intersections 108 may be configured to form any size of angles p and q. But in accordance with a preferred embodiment, said wire intersections 108 form angles p and q having the size of about 90 degrees.

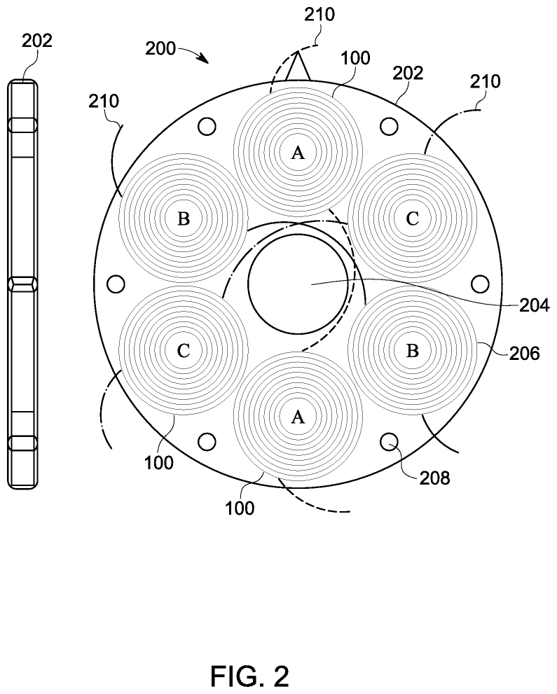

In a preferred embodiment, the stator core 100 per FIGS. 1A and 1B forms part of a stator 200 for power generation. FIG. 2 shows further aspects of a preferred embodiment, wherein the stator 200 comprises a stator-core receptacle 202 for holding the stator cores 100 such that the positions of stator cores 100 are evenly distributed. The stator-core receptacle 202 in accordance with a preferred embodiment is formed of molded fiberglass so as to have an outline of a disc having a generally circular stator's center hole 204 intended for non-contacting insertion of a shaft 404 (not shown in FIG. 2; to be discussed later). The stator-core receptacle 202 is further configured to hold the stator cores 100 by way of providing an equal number of stator-core slots 206 defined by openings into the stator-core receptacle 202, the axes of the stator-core slots 206 and that of the stator's center hole 204 being generally in parallel. The dimensions of stator-core slots 206 are configured so that the stator cores 100 may be sufficiently inserted into. The stator-core slots 206 in a preferred embodiment are positioned on the stator-core receptacle 202 so that the stator-core receptacle 202 may hold the stator cores 100 close to the edge of stator-core receptacle 202 in a way that the stator 200 is substantially symmetric when all the stator-core slots 206 are filled with the stator cores 100 and all the stator cores 100 are held by the stator-core receptacle 202 as intended. Each stator core 100 may be bound or fastened either permanently or temporarily with each corresponding stator-core slot 206. In a preferred embodiment, the stator cores 100 are permanently bound with the internal surfaces of stator-core slots 206 by embedding the stator cores 100 in the stator-core receptacle 202 during the fiberglass molding process at the predetermined positions of stator-core slots 206. Moreover, the stator-core receptacle 202 in this embodiment has six peripheral holes 208 for contacting insertion of auxiliary rods 406 (not shown in FIG. 2; to be discussed later).

As further shown on FIG. 2, one stator 200 is preferably configured to hold three pairs of stator core 100 for the purpose of generating three-phase electricity. It should be noted that the number of stator core 100 per each stator 200 in other embodiments that are not shown here may be an odd or even number that may be fewer or greater than six. Such number depends directly on the number of the intended phases of electricity, without deviating from the concept of the pre sent disclosure.

It should be further noted that, when the stator cores 100 are in a state of being held by the stator-core receptacle 202 as intended for a preferred embodiment, a “pair” of stator cores 100 means that the two respective stator cores 100 are placed in two stator-core slots 206 which are the farthest away from each other on the same stator-core receptacle 202. FIG. 2 illustrates this notion of pairing by way of indicating two stator cores 100 belonging to the same pair with the capitalized letters “A”, “B”, and “C”.

In a preferred embodiment, the stator cores 100 of each pair are electrically connected by way of placing a coupling wire 210 in contact with both the stator cores 100 of the same pair. In this embodiment, the coupling wire 210 has a larger diameter than the stator-core wire 102. As noted above, the number of the stator cores 100 directly corresponds to the number of electricity phases intended to be generated by an embodiment. FIG. 2 depicts a preferred connection of each pair of stator cores 100, wherein the “A” pair is for generation of a first phase of electricity; the “B” pair is for generation of a second phase of electricity; and the “C” pair is for generation of a third phase of electricity.

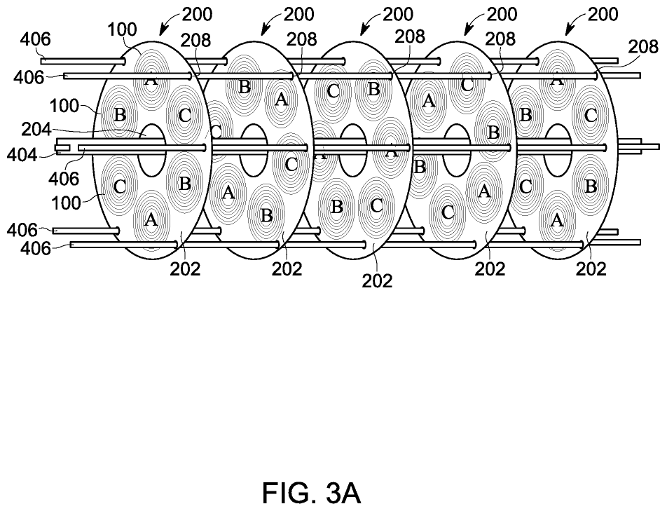

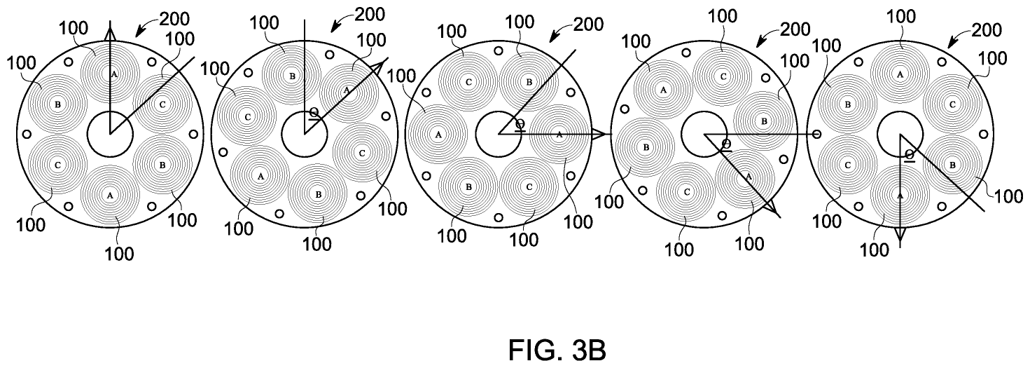

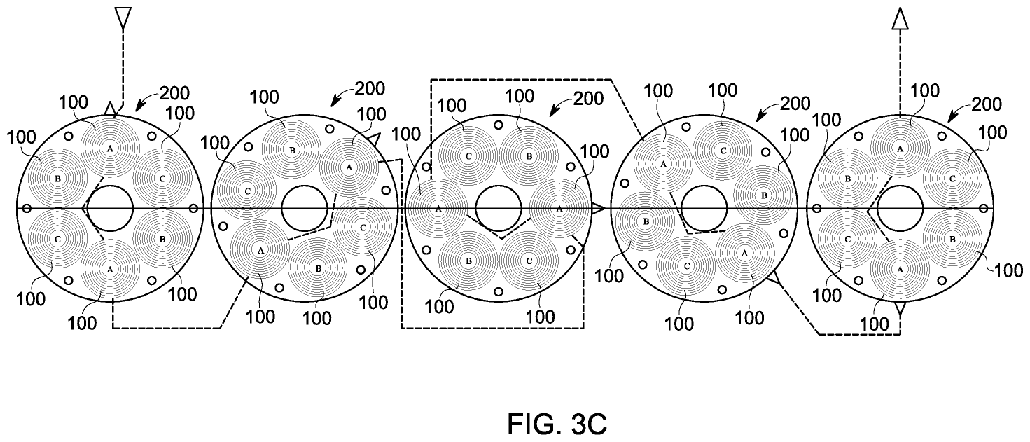

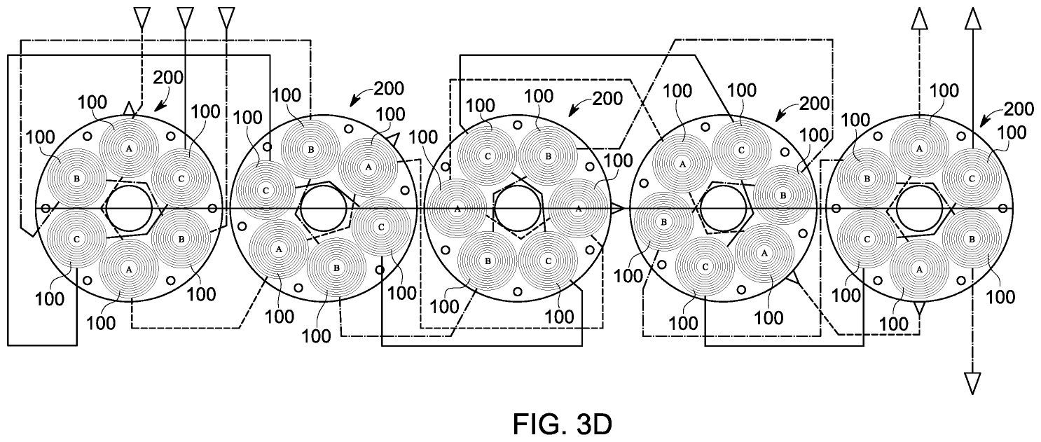

FIG. 3A shows part of yet further aspects of a preferred embodiment. Here, five stators 200 have the stator cores 100 inserted into and bound with all their stator-core slots 206 as intended. The five stators 200 are fixed in coaxial alignment by inserting the auxiliary rods 406 through the peripheral holes 208 of the stator-core receptacles 202. In a preferred embodiment, there are six auxiliary rods 406 (one out of six is omitted from FIG. 3A). On the other hand, the shaft 404 is positioned so as to project through all the stators' 200 center holes 204 without a direct contact. The stators 200 are as well not in direct contact with each other. This way, the assembled stators 200 face their generally circular cross-sectional surfaces towards other stators' 200 cross-sectional surfaces in a manner that the planes defined by each stator's 200 cross-sectional surfaces are generally in parallels, and that the distances between adjacent planes are generally equal.

FIG. 3B further displays a preferred positional relationship between the stator cores 100 in different stators 200. As previously noted, this preferred embodiment is an example intended for generation of three-phase electricity wherein each stator 200 has six stator cores 100. And, as previously noted, each stator core 100 is indicated with “A”, “B”, or “C” to represent the electricity phase that the stator core 100 is intended to generate. Further note that the stator cores 100 in the same stator 200 are electrically connected as per described in the above FIG. 2. But such electrical connection is omitted from FIG. 3B for brevity.

As shown on FIG. 3B, starting from phase “A”, the electricity phases assigned to the stator cores 100 of same stator 200 follow the previously illustrated order: starting from any stator core 100 indicated with “A” and proceeding clockwise in the same stator 200, the order is always A, C, B, A, C, B for this preferred embodiment.

FIG. 3B provides imaginary triangular Markers which are conceptually attached to one of the stator cores 100 assigned with “A” phase. This is to distinguish it from its “A”-phase counterpart in the same stator 200. For additional referencing purpose, the five stators 200 in FIG. 3B will be called from left to right as Stator Nos. 1, 2, 3, 4, and 5. For yet additional referencing purpose, the twelve o'clock position of any stator 200 will be called the 0-degree position, starting from which a clockwise turn will increase an angle's degree.

According to FIG. 3B, the Marker of Stator No. 1 indicates the 0-degree position at which one of the “A”-phase stator cores 100 is placed. Starting from the Marker and proceeding clockwise, the order of assigned electricity phase is A, C, B, A, C, B.

Next is the Stator No. 2 where the Marker indicates the 45-degree position at which one of the “A”-phase stator cores 100 is placed. Starting from the Marker and proceeding clockwise, the order of assigned electricity phase is A, C, B, A, C, B.

Next is the Stator No. 3 where the Marker indicates the 90-degree position at which one of the “A”-phase stator cores 100 is placed. Starting from the Marker and proceeding clockwise, the order of assigned electricity phase is A, C, B, A, C, B.

Next is the Stator No. 4 where the Marker indicates the 135-degree position at which one of the “A”-phase stator cores 100 is placed. Starting from the Marker and proceeding clockwise, the order of assigned electricity phase is A, C, B, A, C, B.

Next is the Stator No. 5 where the Marker indicates the 180-degree position at which one of the “A”-phase stator cores 100 is placed. Starting from the Marker and proceeding clockwise, the order of assigned electricity phase is A, C, B, A, C, B.

With reference to the Markers, the angular displacement per FIG. 3B is incrementally 45 degrees from any one of the stators 200 to the next (i.e. θ=45 degrees).

The above configurations per FIGS. 3A and 3B are intended for providing the stator cores 100 for generation of three-phase electricity in a way that the stator cores 100 for generation of same electricity phase are magnetized at the same instance, while the stator cores 100 for generation of different electricity phases are magnetized at different instances. This objective is achieved while avoiding the difference of potential between the same electricity phases across the different stators 200, and thereby avoiding undesirable electrical discharges. These configurations also have further significance which will be described later below. Likewise, the instances of magnetization will be described later below.

FIG. 3C shows the electrical connection between the stator cores 100 of different stators 200 in accordance with a preferred embodiment. For the following description of FIG. 3C, note that any mentioning of Markers; “A”, “B”, and “C” phases; Stator Nos. 1-5; degree positions, etc. shall have the same meanings as per the earlier mentioning in the description of FIG. 3B.

Particularly, FIG. 3C depicts a preferred embodiment wherein the stators 200 (and stator cores 100 thereof) are serially connected. Such choice of connection is incidental to the preferred embodiment but not in any way essential to implementing the present technical concept. An example of parallel connection will be described later as an alternative embodiment.

More particularly, FIG. 3C depicts the serial connection across stators 200 only in relation to the stator cores 100 to which the electricity phase “A” is assigned.

Per FIG. 3C, Stator No. 1 has two “A”-phase stator cores 100 at its 0-degree and 180-degree positions; Stator No. 2 has two “A”-phase stator cores 100 at its 45-degree and 225-degree positions; Stator No. 3 has two “A”-phase stator cores 100 at its 90-degree and 270-degree positions; Stator No. 4 has two “A”-phase stator cores 100 at its 135-degree and 315-degree positions; and Stator No. 5 has two “A”-phase stator cores 100 at its 180-degree and 0-degree positions.

FIG. 3C further shows the order of preferred serial connection:

starting from Stator No. 1: the 0-degree position, and at the 180-degree position;

continuing to Stator No. 2: the 225-degree position, and at the 45-degree position;

continuing to Stator No. 3: the 90-degree position, and at the 270-degree position;

continuing to Stator No. 4: the 315-degree position, and at the 135-degree position; and

continuing to Stator No. 5: the 180-degree position, and at the 0-degree position.

According to this preferred pattern, starting from one position to the next position in the same stator 200, the degree is increased by 180; continuing from one position in one stator 200 to the next position in the next stator 200, the degree is increased by 45. A person having normal skills in the relevant technical field shall be able to apply the foregoing teaching to implement the serial connections for “B”- and “C”-phases of this preferred embodiment, or to implement the serial connection in other embodiments, such as where there are more than five stators 200.

In any case, FIG. 3D depicts the serial connections for the three electricity phases intended to be generated by a preferred embodiment. The detailed description for FIG. 3D follows the pattern as above-described in respect of FIG. 3C and so is omitted for brevity.

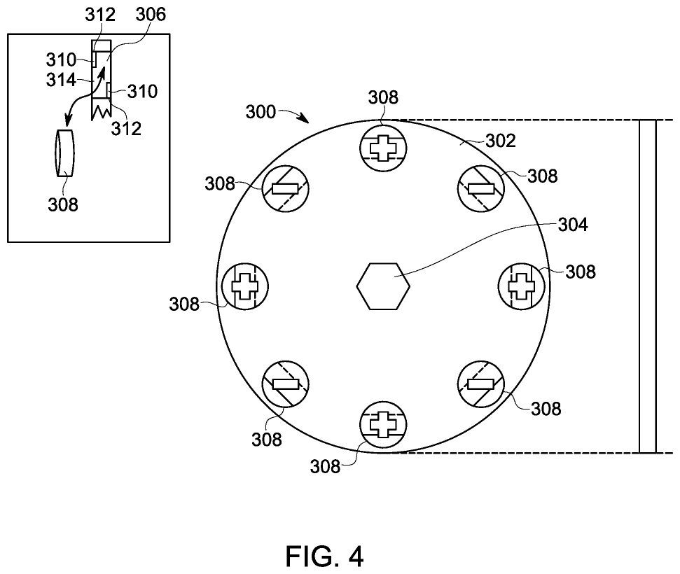

FIG. 4 shows a rotor 300 in accordance with aspects of the preferred embodiment. Here, the rotor 300 comprises a magnet receptacle 302 having an outline of a disc and constructed of a rigid material, preferably a synthetic fiber, more preferably an aramid fiber, and even more preferably a para-aramid fiber. Alternatively, such rigid material may be a fiber-reinforced plastic, wherein the reinforcing fiber is preferably a synthetic fiber, including nylon 6 and aramid fibers.

The magnet receptacle 302 in FIG. 4 comprises a rotor's center hole 304 and eight magnet slots 306, defined by cylindrical openings through the magnet receptacle 302. Each of the magnet slots 306 comprises a means for holding magnets 308. In a preferred embodiment, such means is implemented by way of providing a pair of resilient members 310, preferably slender non-metal strips/fins, affixed to the respective magnet slot's 306 inner surface and in proximity to the generally opposing edges 312 located at different ends of the magnet slot 306, from which the resilient members 310 are configured to protrude generally away from the edges 312 and to partially cover the magnet slot 306, so as to allow intentional insertion or removal of the magnet 308 through a side opening 314 provided by such partial covering, and at the same time to prevent unintentional removal of the magnet 308 which may be caused by the movement of rotor 300 during the intended operation of a preferred embodiment (to be discussed later).

FIG. 4 further shows that the magnets 308 are preferably held close to the edge of magnet receptacle 302 and apart from the adjacent magnets 308 at a generally uniform distance.

In a preferred embodiment, the eight magnets 308 are set such that the polarities thereof are alternating between the adjacent magnets 308 (i.e. North, South, North, South, North, South, North, and South) (North polar is represented on FIG. 4 by a “+”; South polar, by a “−”).

In a preferred embodiment per FIG. 4, the magnet receptacle 302 has the following dimensions: a diameter of about 192 mm; a distance from the rotor's center hole 304 to the center of the magnet slot 306 of about 75.75 mm; and a thickness of about 11 mm. The rotor's center hole 304 here is an opening configured to engagingly receive an object having a shape of a generally hexagonal prism so as to provide a means for engaging with the cross-sectional shape of the shaft 404 (not shown on FIG. 4; discussed later). In this preferred embodiment, each side of the rotor's center hole 304 has a length which substantially corresponds to the diameter of the magnet slot 306.

The magnets 308 may be permanent magnets or electromagnets. In a preferred embodiment, the magnets 308 are neodymium magnets of generally cylindrical shape. The magnet slots 306 here are thus configured to sufficiently encase the magnets 306 of such dimensions and to accommodate the previously discussed means for holding the magnets 308. In this preferred embodiment, the magnets 308 are of 30 mm diameter and 10 mm thickness.

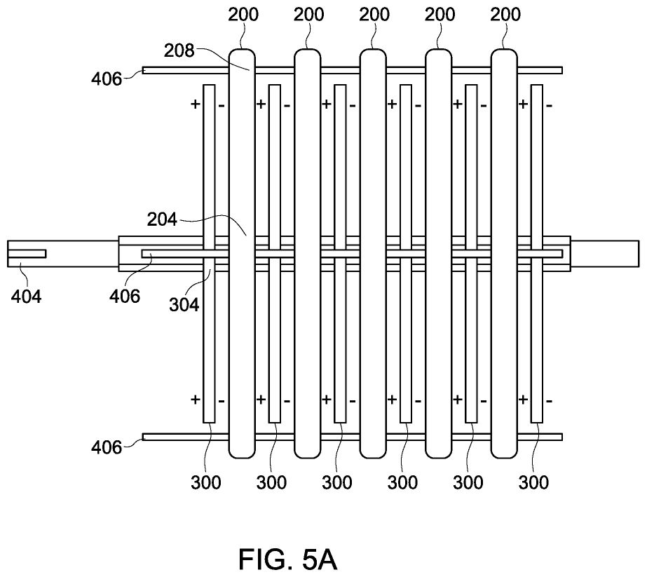

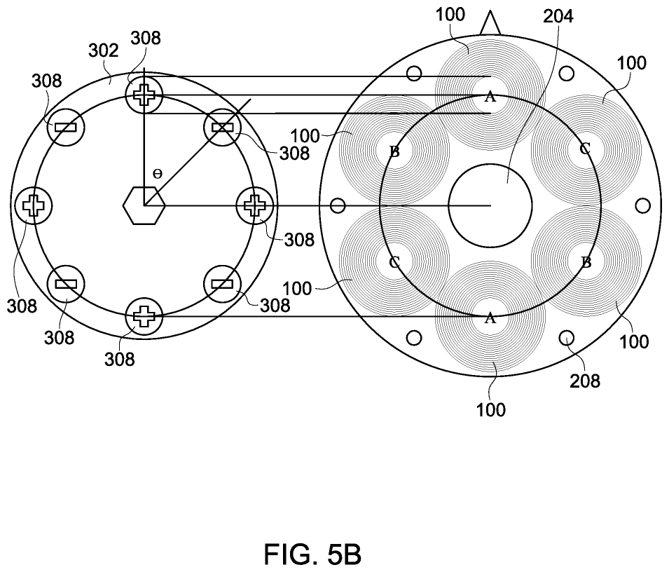

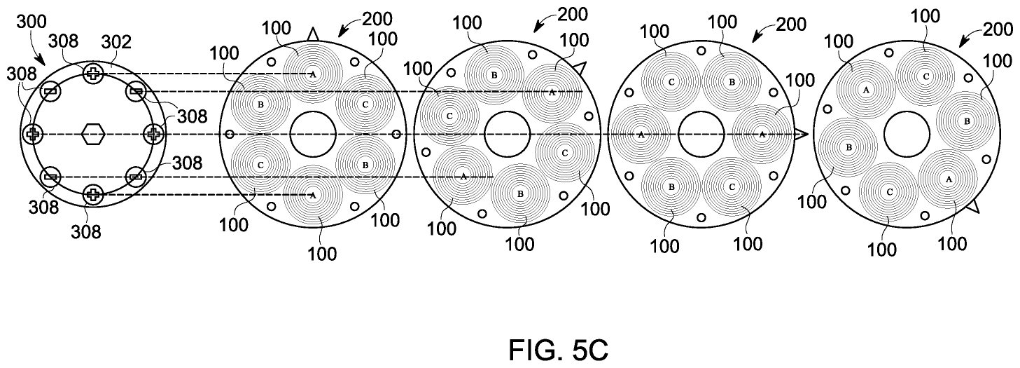

FIG. 5A shows more aspects in accordance with a preferred embodiment where the five stators 200 and six rotors 300 are assembled with the shaft 404 and the auxiliary rods 406. Each of the stators 200 are flanked without direct contact from both sides by two rotors 300, forming a row of members that are alternating between one stator 200 and one rotor 300, aligned generally coaxially, the members at the beginning and the end of such row being the rotors 300. Each stator 200 and its adjacent rotor 300 are spaced sufficiently to let the magnetic induction have effects across such members during the intended operation of this preferred embodiment (more details below). The auxiliary rods 406 are inserted through the peripheral holes 208 of, and are in direct contact with, the stators 200, and more preferably fastened in positions with screws (not shown). But the auxiliary rods 406 are free of direct contact with the rotors 300. Such is enabled by the stators 200 having a larger diameter than the rotors 300, and the peripheral holes 208 being located further from the common axis than the edge of rotors 300. On the other hand, the shaft 404 projects along the common axis through the stators' center holes 204 as well as the rotors' center holes 304, yet the shaft 404 is in direct contact with the rotors' center holes 304 only. Such is enabled by the stators' center holes 204 having a larger diameter than the rotors' center holes 304.

In this preferred embodiment, the distance between the nearest rotors 300 is substantially uniform and approximately 14 mm.

In addition, the stators 200 in FIG. 5A are preferably aligned and configured in accordance with the above-mentioned FIGS. 3A, 3B, 3C and 3D. On the other hand, the rotors 300 in FIG. 5A are preferably aligned such that the North Pole (+) of magnet 308 on one rotor 300 faces against the South Pole (−) of another magnet 308 of the next rotor 300 along and throughout the substantially same axial alignment. In other words, as opposed to the configurations of stators 200 and stator cores 100 per the above FIGS. 3B, 3C, and 3D, the magnets 308 in different rotors 300 do not follow any angular displacement in FIG. 5A. The magnets 308 in all the rotors 300, if located at the same degree position, would face their polarities (+, −) towards the same directions.

Here, the shaft 404 has a generally hexagonal cross-section area so as to engage with the rotor's center hole 304 when assembled in accordance with FIG. 5A. On the other hand, the stator's center hole 204 is of a generally circular shape and substantially wider than the shaft 404 so as to provide a clearance for avoiding a direct contact or engagement with the shaft 404 when assembled in accordance with FIG. 5A. In this way, when the shaft 404 receives mechanical power and rotates thus (to be discussed in detail later), the shaft 404 causes only the engaging rotors 300 to rotate, but leaving the non-engaging stators 200 in their stationary states.

FIG. 5B shows more aspects that are related to a preferred embodiment. In FIG. 5B, only one rotor 300 and one stator 200 from the assembly per FIG. 5A are shown, while the other components are omitted for brevity. In this illustration, the stator 200 is Stator No. 1 per FIGS. 3B, 3C, and 3D above. FIG. 5B focuses on this preferred embodiment's dimensions and placement of stator cores 100 in the stator 200, and magnets 308 in the rotor 300. Particularly,

FIG. 5B shows a side-by-side comparison of the front views of the rotor 300 (left-hand side of FIG. 5B) and the stator 200 (right-hand side of FIG. 5B), assuming that they are now assembled with the shaft 404, the auxiliary rods 406, etc., as illustrated earlier in FIG. 5A, and so the centers of stator 200 and rotor 300 are now aligned at the same level.

According to FIG. 5B, the magnet's 308 diameter (D_{RM}) is about the same as the stator core′ 100 inner diameter (D_{SC, I}), which is 30 mm (i.e. D_{RM}=D_{SC, I}=30 mm).

According to FIG. 5B, the stator 200 has a first imaginary circle having a perimeter upon which the centers of all six stator cores 100 lie; and the rotor 300 has a second imaginary circle having a perimeter upon which the centers of all eight magnets 308 lie. Per this preferred embodiment, the first and second imaginary circles have substantially the same perimeters, which is about 480 mm. In the assembled state of FIG. 5A which is assumed in FIG. 5B, the stator 200 and rotor 300 share a common center. Thus, when projected upon a common plane (e.g. projecting the first imaginary circle from the stator 200 upon the rotor 300, or vice versa), the two perimeters would substantially superimpose each other.

FIG. 5C shows even more aspects that are related to a preferred embodiment. In FIG. 5C, only one rotor 300 and four stators 200 from the assembly per FIG. 5A are shown, while the other components are omitted for brevity. In this illustration, the four stators 200 are Stators Nos. 1, 2, 3, and 4 per FIGS. 3B, 3C, and 3D above. FIG. 5C focuses on this preferred embodiment's angular relations of stator cores 100 in the stators 200 and magnets 308 in the rotor 300. Particularly, FIG. 5C shows side-by-side comparisons of the front views of the rotor 300 (left-hand side of FIG. 5C) and the Stators Nos. 1, 2, 3, and 4 (starting from the one next to the rotor 300 towards the right-hand side of FIG. 5C), assuming that they are now assembled with the shaft 404, the auxiliary rods 406, etc., as illustrated earlier in FIG. 5A, and so the centers of stator 100 and rotor 300 are now aligned at the same level.

In FIG. 5C where there are eight magnets 308 being evenly distributed upon the perimeter of an imaginary circle, it follows that an arc starting from the center of one magnet 308 to the center of next magnet 308 would form an about 45-degree angle within that imaginary circle. Said 45 degrees correspond to the increment of angular displacement from one stator 200 to the next, as discussed above in detail in connection with FIGS. 3B, 3C, and 3D. Accordingly, FIG. 5C shows the magnets 308 at the 0- and 180-degree positions of rotor 300 being aligned with “A”-phase stator cores 100 of Stator No. 1; the magnets 308 at the 45- and 225-degree positions of the rotor 300 being aligned with “A”-phase stator cores 100 of Stator No. 2; the magnets 308 at the 90- and 270-degree positions of the rotor 300 being aligned with “A”-phase stator cores 100 of Stator No. 3; and the magnets 308 at the 135- and 315-degree positions of the rotor 300 being aligned with “A”-phase stator cores 100 of Stator No. 4.

FIG. 5C serves as a simplified example of angular alignment when a preferred embodiment is in its stationary state, as well as a simplified example of angular alignment at a given instance when such preferred embodiment is being operated as intended.

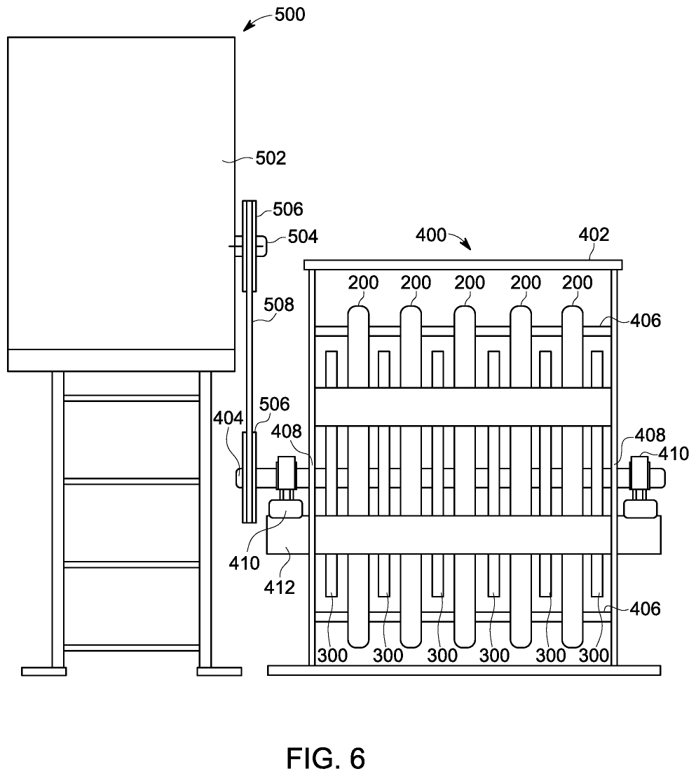

FIG. 6 shows yet further aspects per a preferred embodiment. In these aspects, the row of five stators 200 and six rotors 300 are assembled with the shaft 404 in accordance with FIGS. 5A, 5B, and 5C, and is further assembled with an external case 400 comprising a frame 402 for covering the stators 200, the rotors 300, major part of the shaft 404 and the auxiliary rods 406. In this preferred embodiment, the length of the frame 402 is shorter than that of the shaft 404, and side openings 408 are provided through the opposing sides of the frame 402 such that the shaft 404 may pass the confines of the frame 402. It follows that the diameter of the side openings 408 should provide a sufficient clearance for the shaft's 404 passing and rotation during the intended operation. The foregoing components are preferably assembled so that the axis along the length of the shaft 404 is substantially horizontal with respect to the ground and the stators 200 and rotors 300 are free from direct contact with the frame 402, the ground, and each other. The frame 402 is preferably a box constructed of a solid material, preferably non-conductive and non-magnetizable, and is not necessary to be made so as to cover the substantial entirety of stators 200 and rotors 300. As shown in FIG. 6, the frame 402 is designed to loosely cover such components without affecting the intended working of the present technical disclosure. Preferably, the external case 400 should provide means for supporting the shaft 404 and means for supporting the auxiliary rods 406.

In this preferred embodiment, said means for supporting the shaft 404 is implemented by providing a pair of pillow block bearings 410. In FIG. 6, the pillow block bearings 410 are mounted upon, and fastened to, frame extensions 412 protruding generally away from the sides of the frame 402 having the side openings 408. Such fastening of each of the pillow block bearings 410 to each of the frame extensions 412 may be carried out by a conventional fastening means. The block bearings 410 and frame extensions 412 are preferably located sufficiently close to the side openings 408, so that the shaft 404 passing through both the side openings 408 may be inserted through, and thus supported by, the pillow block bearings 410. In addition to the structural support, the pillow block bearings 410 is intended for facilitating the shaft's 404 rotation during this preferred embodiment's intended normal operation.

In this preferred embodiment, the abovementioned means for supporting the auxiliary rods 406 is implemented by affixing the auxiliary rods 406 to the frame 402, specifically by screwing each end of the auxiliary rod 406 to each side of the frame 402.

After connecting in series each independent phase of the stators 200 in the external case 400, two output wires (not shown) per phase of electricity are used. Such output wires (not shown) are connected to an overload fuse (not shown) of 0.1 mm thickness and from the fuse to any electricity-consuming device. FIG. 6 also shows that the shaft 404, at the proximity to one of its end, is further coupled to a means for supplying mechanical power 500. According to an example per this preferred embodiment, such means is a gasoline engine 502 of 4.8-horsepower capacity. The gasoline engine 502 is coupled with a power-transmitting mechanism 504 comprising of pulleys 506 around which a belt 508 is engagingly mounted. In this preferred embodiment, there are two pulleys 506 of substantially 1:1 size ratio, and the belt 508 is a rubber V-type toothed belt. One of the pulleys 506 is coupled with the gasoline engine 502, and another pulley 506 is coupled with the shaft 404. It follows that each of the pulleys 506 should be configured so as to provide a fitting and engagement that are sufficient to be driven by the gasoline engine 502 and drive the shaft 404, as the case may be.

The description on an intended operation starts from the means for supplying mechanical power 500. In a preferred embodiment, the gasoline engine 502 is started up, providing mechanical power which is transmitted through the power-transmitting mechanism 504. Specifically, such mechanical power drives the rotation of the first pulley 506, which in turn pulls the mounting belt 508, inducing the pulling action that drives the rotation of the second pulley 506 which is engagingly coupled to the shaft 404. As a result, the shaft 404 rotates, with support and facilitation of the pillow block bearings 410 located on both sides of the frame 402 of external case 400. Because the now rotating shaft 404 further engages with the six rotors 300 and not with the five stators 200, only the rotors 300 rotate and the stators 200 remain stationary by the aid of auxiliary rods 406.

During the rotation of rotors 300, the magnets 308, held by the magnet slots 306, provide the magnetic fields for magnetizing the stator cores 100 held on the respective stators 200. Owing to the rotation of rotors 300, such magnetization occurs in an alternating manner—i.e. the stator core 100 is magnetized by a magnetic field in a first direction, and then magnetized by a magnetic field in a second, opposing direction—continuously so long as the rotors 300 remain in motion. This preferred embodiment works effectively at the rotational speed of 4,500-5,000 RPM with load and relation 1:1 but this example RPM range by no means suggests an operational limit of the embodiments per the present technical concept. Such alternating magnetization induces the generation of alternating-current electricity. In a preferred embodiment having three pairs of stator core 100 per stator 200, the generated electricity is three-phase.

The reason for which the above aspects could improve the efficiency of power generation is not entirely known to the applicant, but it is believed that forming the stator core 100 by providing such wire intersections 108 would direct the electromagnetic brake vectors to oppose and offset each other, thereby substantially reducing the retardation effects that would normally occur in the existing power generation systems. In this perspective, the aspects in accordance with the present disclosure are not so much suppressing the electromagnetic brake (which arises naturally per the Lenz's law) as leading the electromagnetic brake towards the directions that are effectively non-retarding.

### Alternative Embodiments

The following alternative embodiments are intended to be further examples for clarifying the breadth of the present technical concept, and for suggesting further adjustments falling within the present technical concept, and thus should not be interpreted in a limiting manner.

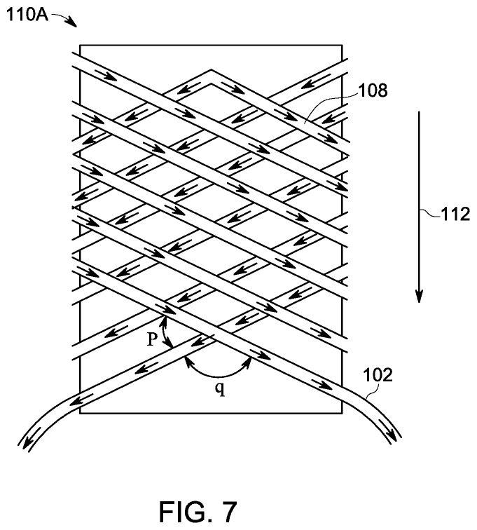

Forming the wire intersections in the stator core. Further to an example of forming wire intersections 108 per the previously described FIG. 1B, the wire intersections 108 may as well be formed in accordance with an alternative configuration as exemplified by FIG. 7. In this alternative embodiment, the stator-core wire 102 is not woven within the same layer. Instead, the stator-core wire 102 is wound towards the predetermined winding direction 112 such that the wire intersections 108 are formed by a plurality of adjoining layers 110A. This alternative shows that the construction of stator core 100 per the concept of the present disclosure relies upon of the stator-core wire's 102 effective crossing within the same spool 106, rather than within the same layer. In other words, the stator-core wire 102 needs to be crossed but does not need to be woven, or even be in direct contact.

In addition, while the above-described preferred embodiments opt the forming of wire intersections 108 by winding one stator-core wire 102 around the nucleus (i.e. the air core 104), such wire intersections 108 may as well be formed by winding two or more stator-core wires 102 around the nucleus. In such alternative embodiment (not shown), the two or more stator-core wires 102 may be joined at one or more positions for ease of winding. Examples of the means for such joining of stator-core wires 102 include: tying the ends (or locations close thereto) of the stator-core wires 102 together, and affixing the ends (or locations close thereto) of the stator-core wires 102 to the nucleus (i.e. in an embodiment that the nucleus is not an air core 104).

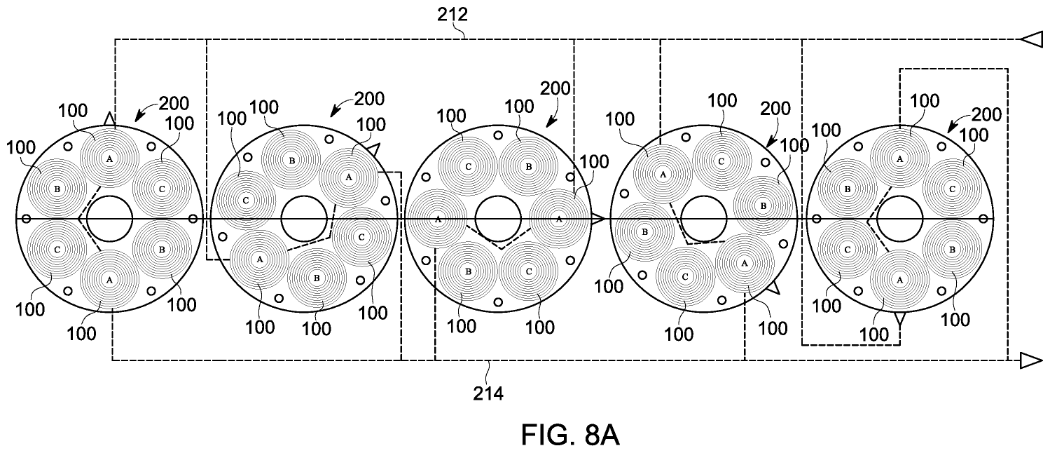

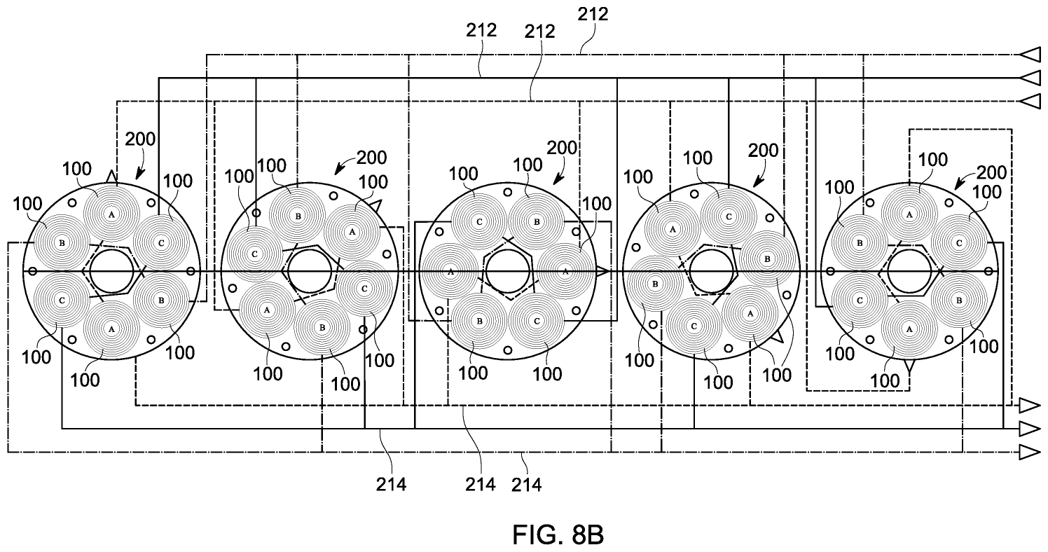

Parallel connection between stators. Further to an example of serial connection between stator cores 100 of different stators 200 per the previously described FIGS. 3C and 3D, the electrical connection may optionally be a parallel connection. FIG. 8A shows yet another alternative embodiment whereby the five stators 200 are connected in parallel. Similarly to the above FIG. 3C, FIG. 8A depicts the parallel connection across stators 200 only in relation to the stator cores 100 to which the electricity phase “A” is assigned.

FIG. 8A provides imaginary triangular Markers which are conceptually attached to the stator cores 100 assigned with “A” phase. This is to distinguish it from its “A”-phase counterpart in the same stator 200. For additional referencing purpose, the five stators 200 in FIG. 8A will be called from left to right as Stator Nos. 1, 2, 3, 4, and 5. For yet additional referencing purpose, the twelve o'clock position of any stator 200 will be called the 0-degree position, starting from which a clockwise turn will increase an angle's degree.

Per FIG. 8A, Stator No. 1 has two “A”-phase stator cores 100 at its 0-degree and 180-degree positions; Stator No. 2 has two “A”-phase stator cores 100 at its 45-degree and 225-degree positions; Stator No. 3 has two “A”-phase stator cores 100 at its 90-degree and 270-degree positions; Stator No. 4 has two “A”-phase stator cores 100 at its 135-degree and 315-degree positions; and Stator No. 5 has two “A”-phase stator cores 100 at its 180-degree and 0-degree positions. FIG. 8A further shows the order of preferred parallel connection:
Stator No. 1: the 0-degree position is connected to a first node 212; the 180-degree position is connected to a second node 214; and the 0-degree position is connected to the 180-degree positon;
Stator No. 2: the 225-degree position is connected to the first node 212; the 45-degree position is connected to the second node 214; and the 225-degree position is connected to the 45-degree positon;
Stator No. 3: the 90-degree position is connected to the first node 212; the 270-degree position is connected to the second node 214; and the 90-degree position is connected to the 270-degree positon;
Stator No. 4: the 315-degree position is connected to the first node 212; the 135-degree position is connected to the second node 214; and the 315-degree position is connected to the 135-degree positon; and
Stator No. 5: the 180-degree position is connected to the first node 212; the 0-degree position is connected to the second node 214; and the 180-degree position is connected to the 0-degree positon.

Here, the stator cores 100 of same electricity phase in the same stator 200 are directly connected. On the other hand, there is no direct connection between the stator cores 100 of different stators 200, but the stator cores 100 of different stators 200 are indirectly connected through the first node 212 and the second node 214. In particular, from one position in one stator 200 that is connected to the first node 212, a position in the next stator 200 at which the degree is increased by 225 is also connected to the first node 212. Likewise, from one position in one stator 200 that is connected to the second node 214, a position in the next stator 200 at which the degree is increased by 225 is also connected to the second node 214. A person having normal skills in the relevant technical field shall be able to apply the foregoing teaching to implement the parallel connection for “B”- and “C”-phases of this alternative embodiment, or to implement the parallel connection in other alternative embodiments, such as where there are more than five stators 200.

In any case, FIG. 8B depicts the parallel connections for all the electricity phases intended to be generated by implementing an alternative embodiment. The detailed description for FIG. 8B follows the pattern as above-described in respect of FIG. 8A and so is omitted for brevity.

1. A system for generation of one or more electricity phases by electromagnetic induction, comprising:
at least one rotor, configured to be capable of rotating around an axis and comprising at least one magnet and;
at least one stator, configured to be stationary and comprising at least one stator core,
wherein the stator core comprises a nucleus; and a wire, wound around said nucleus;
wherein the wire is wound towards a winding direction such as to form a plurality of wire intersections;
wherein said system is configured to receive mechanical energy for inducing the rotor to rotate around the axis;
wherein the rotor and the stator are aligned alternatingly, coaxially and free of a direct contact; and
wherein the magnet and the nucleus have substantially the same cross-sectional dimensions.

2. The system of claim 1, wherein the number of said magnets is determined by rounding up the product of an expression:
(1+1/N_{EP})×N_{SC} Formula (1)
wherein N_{EP} is the number of electricity phases, and N_{SC} is the number of stator cores.

3. The system of claim 2, wherein N_{SC} is a multiple of N_{EP}.

4. The system of claim 1, wherein each wire intersection forms two pairs of opposite angles, each angle being substantially 90 degrees.

5. The system of claim 1, wherein the nucleus is non-magnetizable.

6. The system of claim 5, wherein the nucleus is an air core.

7. The system of claim 1, wherein the stator comprises a receptacle for holding the stator core.

8. The system of claim 7, wherein the receptacle has a substantially symmetric shape.

9. The system of claim 7, wherein the receptacle is formed of an electrical insulation material.

10. The system of claim 7, wherein the receptacle is configured to hold a plurality of stator cores such that the positions of stator cores are evenly distributed.

11. The system of claim 10, wherein the stator cores are electrically coupled in pair or pairs or an odd number.

12. The system of claim 1, comprising a plurality of stators.

13. The system of claim 1, comprising a plurality of rotors.

14. A process for generating one or more electricity phases by electromagnetic induction, comprising: rotating a rotor relatively to a fixed stator, said rotor and said stator being aligned alternatingly, coaxially, and free of a direct contact, said rotor comprising at least one magnet, and said stator comprising at least one stator core, wherein the stator core comprises a nucleus; and a wire, wound around said nucleus; wherein the wire is wound towards a winding direction such as to form a plurality of wire intersections, and wherein the magnet and the nucleus have substantially the same cross-sectional dimensions.

15. The process of claim 14, wherein a plurality of rotors are rotated simultaneously.

16. The process of claim 14, wherein the number of said magnets is determined by rounding up the product of an expression:
$$( 1 + \frac{1}{{N}_{EP}} ) \times {N}_{SC} \qquad Formula ( 1 )$$
wherein N_{EP} is the number of electricity phases, and N_{SC} is the number of stator cores.

17. The process of claim 16, wherein N_{SC} is a multiple of N_{EP}.

18. The process of claim 16, wherein the rotation of said rotor causes said stator core to be magnetized in an alternating manner by a magnetic field in a first direction and by a magnetic field in a second direction.

19. The process of claim 14, wherein said stator comprises a plurality of stator cores, the positions of which are evenly distributed upon said stator.

20. The process of claim 14, wherein the nucleus is an air core.

21. A method of manufacturing a wire spool, comprising winding of two or more independent and magnetizable wires in opposite directions.

22. The method of claim 21, wherein the wires are consecutively and alternately wound, and wherein the winding starts from the center and or the bottom of the coil, and end with two wires on the surface of the coil, and wherein the wires are joined at the beginning so that the coil has electrical continuity when it is magnetically induced.
